(19) United States
(12) Patent Application Publication
(10) Pub. No.: US 2012/0062428 A1
(43) Pub. Date: Mar. 15, 2012

(54) PORTABLE RADIO

(75) Inventors: Daigo Imano, Miyagi (JP); Jun Sawada, Miyagi (JP); Takeshi Yamaguchi, Kanagawa (JP)

(73) Assignee: PANASONIC CORPORATION, Osaka (JP)

(21) Appl. No.: 13/320,894

(22) PCT Filed: Mar. 2, 2010
(86) PCT No.: PCT/JP2010/001429

§ 371 Date: Nov. 16, 2011

(30) Foreign Application Priority Data
May 28, 2009 (JP) 2009-129090

(51) Int. Cl. H01Q 1/24

(52) U.S. Cl. 343/702

(57) ABSTRACT

There is provided a portable radio that exhibits high waterproof property and dust resistance property without impairing toughness and antenna performance while pursuing a smaller size.

A portable radio 100 has a first case member 11 and a second case member 15 to be joined to a surrounding area of an opening of the first case member 11 by way of a soft seal member 13 and houses a circuit board 19 connected to an antenna element 17 within a case. The seal member 13 has an annular structure including a first extension part 35 made of a nonconductive material and a second extension part 37 to be connected to both ends of the first extension part 35, in which a conductive material included in at least a portion of the second extension part serves as the antenna element, a passive element, and an earth line. A hardness of the seal member 13 exhibits substantially the same hardness in both the first extension part 35 and the second extension part 37.

### TECHNICAL FIELD

The present invention relates to a portable radio.

### BACKGROUND ART

In relation to a portable radio, such as a cell phone unit, a period during which a user uses one portable radio has recently become longer. Further, in order to lessen constrains on use environments of the portable radios, demands for portable radios having enhanced toughness, waterproof property, and dust resistance property exist in the market. Moreover, some recent portable radios have applications installed, wherein the applications use low frequency bands, such as TV, radio, and RFID (Radio Frequency Identification). In relation to an antenna used for the applications, a length of an antenna element must be assured in order to acquire a desired antenna gain. In general, a length that is a quarter to one-half of a usable frequency is required. From the viewpoint of a design, there exists a demand for a portable radio having a built-in antenna element that does not protrude out of an enclosure. When the antenna element is accommodated, there is no alternative but to increase the size of the portable radio itself, because the antenna element is long and a distance between the antenna element and a circuit board must be assured in order to ensure a desired antenna characteristic.

In light of the circumstance, there is a known configuration; namely, a frame-shaped seal member is laid between mutually-opposing faces that each surround an open surface of a rear case and an open surface of a front case in a portable radio, and an antenna element is embedded in the seal member (see; for instance, Cited Reference 1).

### RELATED ART DOCUMENT

### Patent Document

Patent Document 1: Japanese Patent No. 3248250

### SUMMARY OF THE INVENTION

### Problem that the Invention is to Solve

As described in connection with Cited Document 1, in order to get a distance between the circuit board and the antenna element and the length of the antenna element, the antenna element is embedded in the seal member, whereby the antenna element and the seal member are commoditized. This enables miniaturization of the portable radio, but on the other hand, sealing performance of the seal member is deteriorated. Specifically, the seal member includes two areas; namely, an area where the antenna element is embedded and another area where the antenna element is not embedded. The hardness of the seal member becomes discontiguous in a border between the two areas. For this reason, when the portable radio is submerged, water pressure exerted on the seal member becomes uneven at the border, which can be a factor of intrusion of water into the case of the portable radio.

The present invention has been conceived in view of the circumstance and aims at providing a portable radio that exhibits high waterproof property and dust resistance property without involvement of impairment of toughness and antenna performance while miniaturization of the portable radio is pursued.

### Means for Solving the Problem

The present invention provides a portable radio that has a first case member and a second case member to be joined to a surrounding area of an opening of the first case member by way of a soft seal member and that houses a circuit board connected to an antenna element within a case resulting from the first case member having been joined to the second case member, wherein the seal member has an annular structure including a first extension part made of a nonconductive material and a second extension part to be connected to both ends of the first extension part, in which a conductive material included in at least a portion of the second extension part serves as the antenna element, a passive element, and an earth line; and wherein the seal member exhibits substantially the same hardness in the first extension part and the second extension part.

By means of the configuration, the first extension part and the second extension part exhibit substantially the same hardness in the seal member. When the case members are joined, the seal member is uniformly brought into close contact with the entire circumference of the opening of the case member. Further, local unevenness does not occur in elastic restoring force of the seal member. Accordingly, the portable radio can be configured with high hermeticity in such a way that waterproof property and dust resistance property are reliably, stably achieved in the case.

The present invention also provides the portable radio, wherein the second extension part is made of a conductive elastic member prepared by dispersing a conductive filler in an elastic material.

By means of the configuration, the second extension part is made of a conductive elastic material solely exhibiting electrical conductivity. Hence, the hardness of the first extension part and the hardness of the second extension part can be made readily equal by means of; for instance, controlling the amount of conductive filler added, selecting the type of elastic material, and the like.

The present invention also provides the portable radio, wherein the second extension part is made up of a conductive core material and a jacketing material that covers an exterior of the core material and that is made of a nonconductive material.

By means of the configuration, an exterior of the conductive core material is covered with the nonconductive jacketing material. Hence, even when the seal member is immersed in water, insulation of the core material is held, and a degree of deterioration of an antenna characteristic can be reduced.

The present invention also provides the portable radio, wherein the seal member is put on the surrounding area of the opening of either the first case member or the second case member, and the circuit board equipped with an electrical connection terminal is put in either one of the case members, wherein the second extension part is connected to a connection extension part that extends from a portion of the second extension part along an inner surface of the one case member, and wherein the connection extension part and the electric connection terminal are electrically connected when the case members are joined.

By means of the configuration, the connection extension part is provided along the inner surface of the case member. Contact pressure exerted between the connection extension part and the electric connection terminal can be stably assured, so that superior electrical connectivity is acquired.

The present invention also provides the portable radio, wherein the connection extension part extends from a portion of the second extension part toward an interior of the seal member having an annular structure.

By means of the configuration, the connection extension part is connected to the circuit board placed at the interior of the annular seal member where waterproof property and dust resistance property are assured. Thus, even when submerged, the portable radio can assure a stable antenna characteristic.

The present invention also provides the portable radio, wherein the second extension part is fed with electrical power from the electric connection terminal of the circuit board, thereby making up a monopole antenna element.

By means of the configuration, the second extension part is fed with electric power from the circuit board, to thus act as a monopole antenna. An antenna configuration that yields a desired gain can be configured.

The present invention also provides the portable radio, wherein the second extension part is split into two; a third extension part connects the two second extension parts together and is made of a nonconductive material; and the two second extension parts are fed with electric power from the electric connection terminal of the circuit board, thereby making up a dipole antenna element.

By means of the configuration, the second extension part and the third extension part are fed with electric power from the circuit board, to thus act as a dipole antenna. An antenna that yields a desired gain can thereby be configured.

The present invention also provides the portable radio, wherein both ends of the second extension part are fed with electric power from the electric connection terminal of the circuit board, thereby making up a balanced loop antenna element.

By means of the configuration, the second extension part is fed with electric power from the circuit board, to thus act as a balanced loop antenna. An antenna that yields a desired gain can thereby be configured.

The present invention also provides the portable radio, wherein the electric connection terminal of the circuit board is made up of a feed terminal and an earth terminal; the connection extension part has a feed extension part that extends out of one end of the second extension part and that is connected to the feed terminal and an earth extension part that extends out of another end of the second extension part and that is connected to the earth terminal; and the second extension part makes up an unbalanced loop antenna element.

By means of the configuration, the second extension part serves as an unbalanced loop antenna, whereby an antenna that has a desired gain can be configured.

The present invention provides the portable radio, wherein the electric connection terminal of the circuit board is made up of a feed terminal and an earth terminal; the connection extension part has a feed extension part that extends out of one end of the second extension part and that is connected to the feed terminal and an earth extension part that extends out of a point on the second extension part close to a location connected to the feed extension part; and the second extension part makes up an inverted-F antenna element.

By means of the configuration, the second extension part serves as an inverted-F antenna, and the distance between the ground of the circuit board and the antenna element can be reduced. Accordingly, the size of the portable radio itself can be further reduced.

The present invention also provides the portable radio, wherein the electric connection terminal of the circuit board is made up of a feed terminal and an earth terminal; the antenna element is connected to the feed terminal; an extension part terminal extending out of the second extension part is connected to the earth terminal; and the second extension part serves as an earth line.

By means of the configuration, the second extension part is connected to the earth terminal of the circuit board, to thus act as an earth line. Hence, antenna performance is enhanced.

The present invention also provides the portable radio, wherein the seal member is put on the surrounding area of the opening of any one of the first and second case members; the circuit board and the antenna element are arranged in any case member; the antenna element and an electric connection terminal provided on the circuit board are electrically connected together; and the second extension part makes up a passive element.

By means of the configuration, the second extension part serves as a passive element, and antenna performance is enhanced.

The present invention also provides the portable radio, wherein the electric connection terminal of the circuit board is made up of an elastic metal forcing member that presses the connection extension part when the case members are joined together.

By means of the configuration, the metal electrical connection terminal exhibiting elastic force stably maintains an electric connection with the connection extension part.

### Advantage of the Invention

The present invention makes it possible to provide a portable radio capable of exhibiting high waterproof property and dust resistance property without impairing toughness and antenna performance while pursuing a smaller size.

### BRIEF DESCRIPTION OF THE DRAWINGS

FIG. 1 is a schematic diagram showing an example configuration of a portable radio of a first embodiment of the present invention.

FIG. 2 is an exploded perspective view of the portable radio shown in FIG. 1.

FIG. 3 is a cross sectional view taken along line A-A shown in FIG. 1.

FIG. 4 is an explanatory view of a state of distribution of stress exerted on a border between a first extension part and a second extension part accommodated in respective trenches.

FIG. 5 is a schematic diagram showing a first modification of the portable radio of the first embodiment of the present invention.

FIG. 6 is a schematic diagram showing a second modification of the portable radio of the first embodiment of the present invention.

FIG. 7 is a schematic diagram showing a third modification of the portable radio of the first embodiment of the present invention.

FIG. 8 is a schematic diagram showing a fourth modification of the portable radio of the first embodiment of the present invention.

FIG. 9 is a schematic diagram showing an example configuration of a portable radio of a second embodiment of the present invention.

FIG. 10 (A) is a cross sectional view of a second extension part, and FIG. 10(B) is a cross sectional view of the second extension part taken along line B-B shown in FIG. 9.

FIG. 11 is a schematic diagram showing an example configuration of a portable radio of a third embodiment of the present invention.

FIG. 12 is a cross sectional view taken along line C-C shown in FIG. 11.

FIG. 13 is a cross sectional view taken along line D-D shown in FIG. 11.

FIG. 14 is a schematic diagram showing an example configuration of the portable radio employing a second extension part whose exterior is covered with a nonconductive jacking material.

FIG. 15 is a schematic diagram showing an example configuration of a portable radio of a fourth embodiment of the present invention.

FIG. 16 is a schematic diagram of the portable radio employing the second extension part whose exterior is covered with a nonconductive jacketing material.

### EMBODIMENTS FOR IMPLEMENTING THE INVENTION

Embodiments provided below show an example configuration of a portable radio achieved when the present invention is applied to a portable terminal unit, like a cell phone. The present invention is applicable to various portable radios that the user can carry.

### First Embodiment

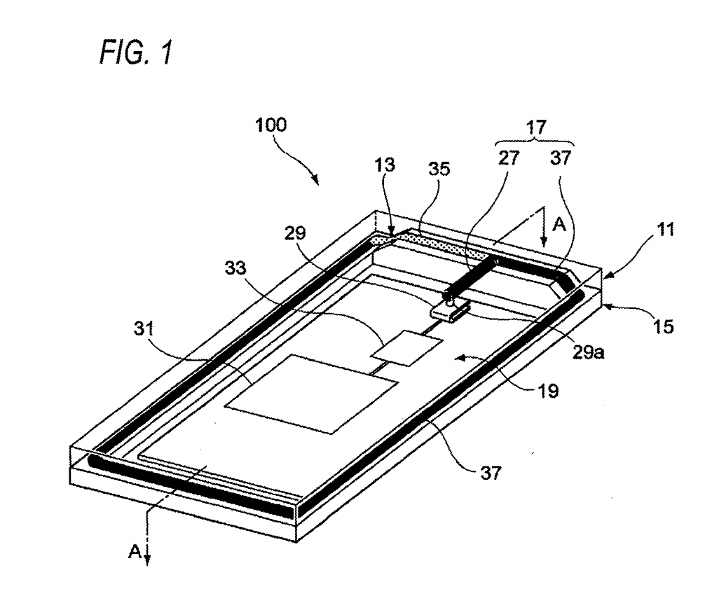

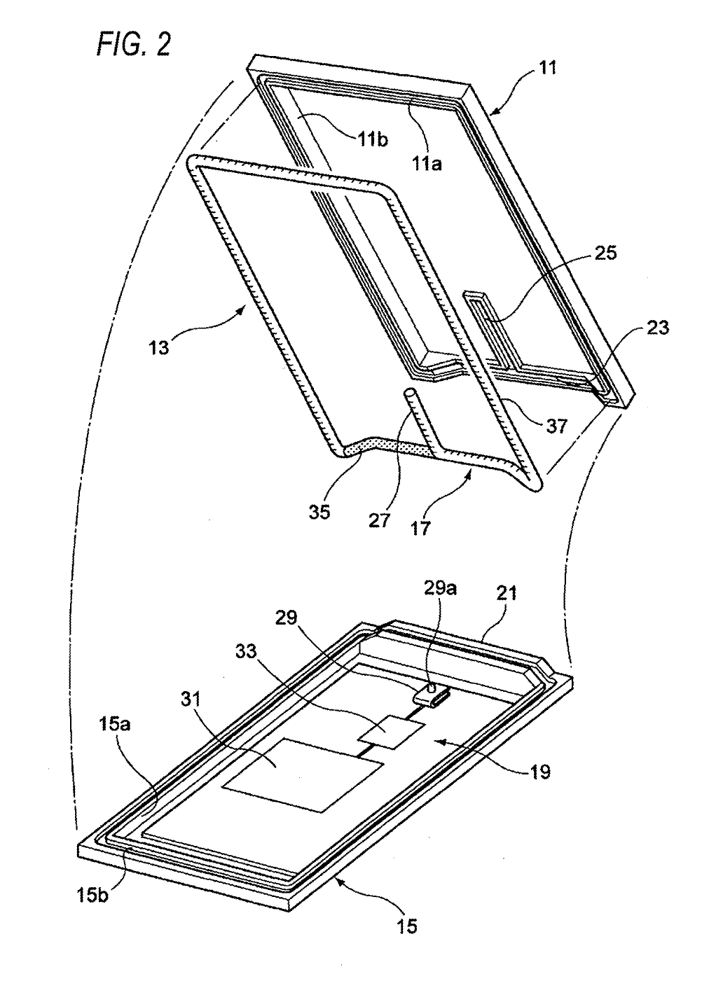

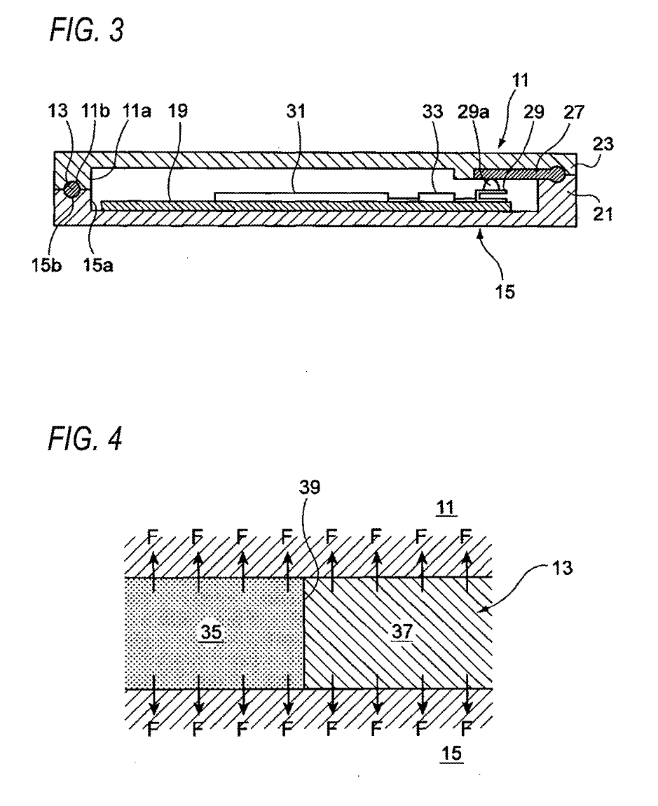

FIG. 1 is a schematic diagram showing an example configuration of a portable radio and also constituent elements in a case in a visible form. FIG. 2 is an exploded perspective view of the portable radio shown in FIG. 1, and FIG. 3 is a cross sectional view taken along line A-A shown in FIG. 1.

A portable radio 100 shown in FIGS. 1 through 3 includes a circuit board to which an antenna element is connected and that is set in a pair consisting of upper and lower members that make up an enclosure. Specifically, the portable radio 100 has a first case member (hereinafter called an “upper case”) 11 and a second case member (hereinafter called a “lower case”) 15 that is joined to a surrounding area of an opening of the first case member 11 by way of a soft seal member 13. A circuit board 19, to which an antenna element 17 (to be described in detail later) formed from a portion of the seal member 13 is connected, is housed in a case (an enclosure) made by joining together the upper case 11 and the lower case 15 by means of un-illustrated fastening members, like screws and engagement claws.

As shown in FIG. 2, a sidewall 15a is built along an entire circumference of the lower case 15, and a sidewall 11a is built along an entire circumference of the upper case 11. A trench 11b that accommodates the seal member 13 is formed in a top face of the sidewall 11a, and a trench 15b that accommodates the seal member 3 is formed in a top face of the sidewall 15a. A protrusion 21 protruding toward the upper case 11 is provided in a portion of the sidewall 15a of the lower case 15. Further, an indentation 23 corresponding to the protrusion 21 is provided at a position in the sidewall 11a of the upper case 11 facing the protrusion 21. The trench 15b is also formed so as to continually run through the protrusion 21, thereby forming an annular trench. Likewise, the trench 11b is also formed so as to continually run through the indentation 23, thereby forming an annular trench.

The upper case 11 has a trench 25 that extends toward an interior of the case from a portion of the indentation 23 of the sidewall 11a. A connection extension part 27 of the seal member 13 can be accommodated in the trench 25.

The circuit board 19 is set on a bottom at the interior of the sidewall 15a of the lower case 15. The circuit board 19 operates as a ground board of the antenna element 17. The circuit board 19 includes an electrical connection terminal 29 that serves as an electrical contact point for the antenna element 17; a radio section 31 that establishes radio communication of a transmission/receipt signal to the antenna element 17; and a matching circuit 33 that matches input impedance of the antenna element 17 to impedance of the radio section 31. The electrical connection terminal 29 has a contact point 29a provided on an elastic metal forcing member, like a leaf spring. The electrical connection terminal 29 is formed in a vicinity of an end of the circuit board 19 so that it can be disposed in close proximity to the protrusion 21 of the lower case 15.

As shown in FIG. 3, when the upper case 11 and the lower case 15 are joined together by way of the seal member 13, the contact point 29a of the electrical connection terminal 29 stably contacts the connection extension part 27 of the seal member 13 at predetermined contact pressure. A superior electrical connection characteristic is thereby acquired.

The seal member 13 is now described. The seal member 13 is formed from a soft elastic member and serves as an annular packing. The seal member 13 comes into close contact with the top surfaces of the sidewalls 11a and 15a of the upper case 11 and the lower case 15, thereby hermetically sealing the interior of the case. The seal member 13 has a first extension part 35 made of a nonconductive material and a second extension part 37 connected to both ends of the first extension part 35, and a conductive material included in at least a portion of the second extension part 37 serves as the antenna element 17. The first extension part 35 and the second extension part 37 are made of different materials. Both ends of the first extension part 35 are connected to the second extension part 37, and the entirety of the seal member 13 is formed in an annular shape.

The previously-described connection extension part 27 extending along an inner surface of the upper case 11 is connected to any one of points of connection between the second extension part 37 and the first extension part 35. The connection extension part 27 exhibits conductivity. When the upper case 11 and the lower case 15 are joined, the connection extension part 27 is accommodated in the trench 25 of the upper case 11 so as to be electrically connected to the electrical connection terminal 29 of the circuit board 19.

The first extension part 35 is made of a soft insulating, elastic resin material exhibiting a superior electrical insulation property, superior repellency, superior chemical resistance, and the like, such as silicone rubber. In addition, for instance, styrene butadiene rubber (SBR), butadiene rubber (BR), ethylene propylene rubber (EPDM), nitrile rubber (NBR), fluorine rubber, urethane rubber, and the like, can be used. The second extension part 37 is made of an elastic material that has hardness substantially equal to that of the first extension part 35 and exhibits conductivity. The second extension part 37 is produced by adding a conductive filler, such as carbon black, metal powder, metal fibers, and the like, to the other elastic material like silicone rubber and vulcanizing (cross-linking) the mixture. Because of ease of processing and ease of control of electrical conductivity, carbon black is particularly preferable as the conductive filler. The second extension part 37 can be made of the same material as that of the connection extension part 27.

FIG. 4 shows an explanatory view of a state of distribution of stress exerted on a border between the first extension part and the second extension part accommodated in the respective trenches. The first extension part 35 and the second extension part 37 of the seal member 13 are joined together by way of a dissimilar material interface 39. When the upper case 11 and the lower case 15 are joined together, substantially identical compressive force is exerted on the first extension part 35 and the second extension part 37, respectively. Since the seal member 13 exhibits substantially the same hardness in both the first extension part 35 and the second extension part 37, elastic restoring force F developing in the first extension part 35 and elastic restoring force F developing in the second extension part 37 form a substantially uniform distribution across the dissimilar material interface 39. Specifically, internal stress of substantially the same level keeps acting on both the first extension part 35 and the second extension part 37 including an area of connection there between. Thus, no difference exists between the first extension part 35 and the second extension part 37 in terms of sealing performance. Accordingly, uniform sealing performance is exhibited over the entirety of the seal member 13 including the first extension part 35 and the second extension part 37; namely, the entire circumference of the seal member 13.

An expression “hardness of the seal member” referred to in the present specification implies that hardness is based on a macroscopic elastic constant achieved in a direction of a longitudinal cross section of the seal member 13, like a hardness value that is defined in; for instance, JIS K6253 and that is determined from a depth to which a push pointer is to be pushed against a surface of a test specimen by way of a spring. Hence, the hardness of the seal member does not simply mean the hardness of an extremely thin surface layer of the seal member 13.

A method for adjusting the hardness of the seal member 13 in such a way that both the first extension part 35 and the second extension part 37 exhibit substantially the same hardness is to select a constituent material of the seal member 13 or prepare a conductive material in such a way that the hardness of either the first extension part 35 or the second extension part 37 is taken as a reference and that the hardness of the remaining extension part matches the reference hardness.

When the second extension part 37 exhibiting conductivity is made of a composite material prepared by mixing an elastic material with a conductive filler, the hardness of the second extension part 37 can be adjusted by means of an amount of conductive filler added. In this regard, the amount of conductive filler added determines conductivity of the conductive material. Hence, hardness (JIS K6253) is set within a range from about 80 at which conductivity similar to that of metal is achieved to a minimum of about 20.

In the portable radio 100 having the foregoing configuration, the seal member 13 exhibits substantially the same hardness in both the first extension part 35 and the second extension part 37. When the upper case 11 and the lower case 15 are joined together by means of a fastening member, like a screw and an engagement claw, the seal member 13 uniformly makes a close contact with the upper case 11 and the lower case 15 over the entire circumference of openings thereof. Further, local inconsistency does not arise in elastic restoring force of the seal member 13 including the border between the first extension part 35 and the second extension part 37. Therefore, the portable radio 100 can be configured with a high degree of hermeticity that provides an interior of the case with stable, reliable waterproof property and dust resistance property.

As shown in FIG. 1, the second extension part 37 exhibiting conductivity is connected to the electrical connection terminal 29 of the circuit board 19 by way of the connection extension part 27. Upon receipt of electrical power from the electrical connection terminal 29, the antenna element 17 made up of the second extension part 37 and the connection extension part 27 serves as a monopole antenna.

The antenna element 17 is laid so as to surround a circumference of the circuit board 19. Even when the antenna element 17 is long, a space between the circuit board 19 and the antenna element 17 can be assured without involvement of an increase in the size of the portable radio 100. Desired antenna performance can be stably acquired. Further, the number of components is reduced by utilizing the seal member 13 as the antenna element 17. Thus, the portable radio 100 can be configured with superior economy and contribute to a reduction in weight and thickness.

The connection extension part 27 of the seal member 13 extends toward an interior of the seal member 13 having an annular structure and an interior of a case from the second extension part 37. The connection extension part 27 is thereby connected to the circuit board 19 at the interior of the seal member 13 where waterproof property and dust resistance property are assured. Therefore, even when the portable radio 100 gets wet or becomes submerged, a stable antenna characteristic can be assured without being affected by the effect of water. Even when environments are very dusty, high hermeticity can be maintained.

Accordingly, the portable radio 100 having the foregoing configuration provides high waterproof property and dust resistance property without impairing toughness and antenna performance while pursuing a smaller size. Thus, constraints on use environments of the portable radio 100 can be lessened.

Modifications of the portable radio of the embodiment are now described.

### First Modification

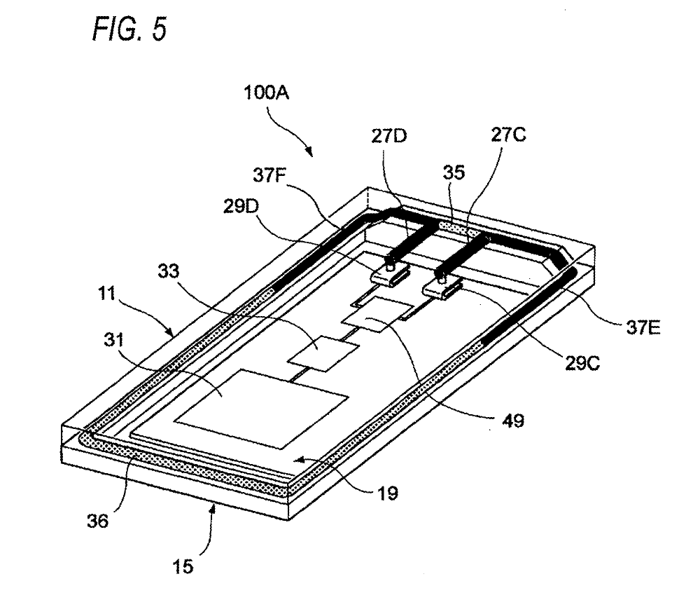

FIG. 5 is a schematic diagram showing a first modification of the portable radio of the first embodiment of the present invention. In explanations provided below, constituent elements that are the same as those of the members shown in FIG. 1 are assigned the same reference numerals, and their explanations are simplified or omitted.

As shown in FIG. 5, in a portable radio 100A, two electric connection terminals of feed terminals 29C and 29D are put on the circuit board 19. The seal member 13 has two second split extension parts 37E and 37F as the second conductive extension part that is to act as the antenna element 17. A feed extension part 27C extends from one end of the second extension part 37E that is joined to one end of the first extension part 35. A feed extension part 27D extends from one end of the second extension part 37F that is joined to the other end of the first extension part 35.

An area between base ends of the feed extension parts 27C and 27D is embodied as the first nonconductive extension part 35. A seal member existing between one end of the second extension part 37E and one end of the second extension part 37F is connected to the first extension part 35. Moreover, an area between the other end of the conductive second extension part 37E and the other end of the conductive second extension part 37F is embodied as a nonconductive third extension part 36. The third extension part 36 is connected to a seal member, to thus form an annular structure. The feed terminals 29C and 29D are connected to the matching circuit 33 by way of a balun 49 that converts a balanced line and an unbalanced line and further to the radio section 31.

The configuration provides an antenna configuration that exhibits the same high waterproof property and dust resistance property as those mentioned above and in which the second extension parts 37E and 37F act as the dipole antenna element 17, to thus yield a desired gain.

### Second Modification

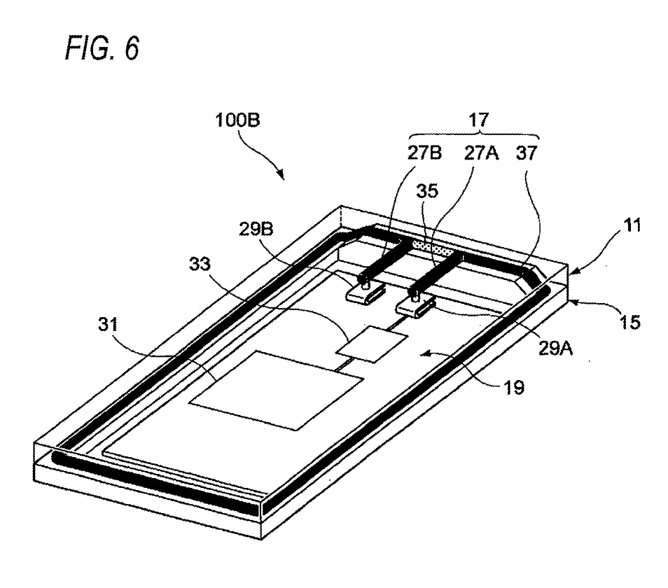

FIG. 6 is a schematic diagram showing a second modification of the portable radio of the first embodiment of the present invention.

As shown in FIG. 6, a portable radio 100B includes two types of electric connection terminals; namely, a feed terminal 29A and an earth terminal 29B, provided on the circuit board 19. A feed extension part 27A extends from one end of the second extension part 37 that is to be joined to the first extension part 35, and the feed extension part 27A is connected to the feed terminal 29A. An earth extension part 27B extends from the other end of the second extension part 37 that is to be joined to the first extension part 35. The earth extension part 27B is connected to the earth terminal 29B.

An area between the point of the conductive second extension part 37 connected to the feed extension part 27A and the point of the same connected to the earth extension part 27B is embodied as the nonconductive first extension part 35. A seal member laid along the second extension part 37 is connected at both ends thereof to the first nonconductive extension part 35, thereby making up an annular structure.

The configuration provides the same high waterproof property and dust resistance property as those yielded in the above, and the second extension part 37 serves as the antenna element 17 of unbalanced loop, so that an antenna configuration that provides a desired gain is accomplished.

### Third Modification

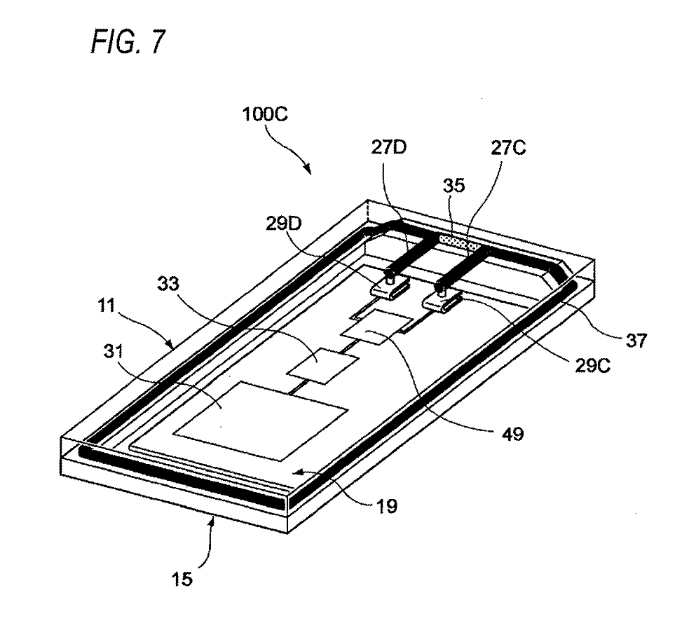

FIG. 7 is a schematic diagram showing a third modification of the portable radio of the first embodiment of the present invention.

As shown in FIG. 7, a portable radio 100C includes two electric connection terminals; namely, the feed terminals 29C and 29D, provided on the circuit board 19. The feed extension parts 27C and 27D extend from both ends of the second extension part 37 that are to be joined to the first extension part 35. The feed extension part 27C is connected to the feed terminal 29C. The feed extension part 27D is connected to the feed terminal 29D.

An area between base ends of the respective feed extension parts 27C and 27D is embodied as the nonconductive first extension part 35. A seal member laid along the second extension part 37 is connected at both ends thereof to the first nonconductive extension part 35, thereby making up an annular structure. Further, the feed terminals 29C and 29D are connected to the matching circuit 33 by way of the balun 49 that converts a balanced line and an unbalanced line and further to the radio section 31.

The configuration provides the same high waterproof property and dust resistance property as those yielded in the above, and the second extension part 37 serves as the antenna element 17 of balanced loop, so that an antenna configuration that provides a desired gain is accomplished.

### Fourth Modification

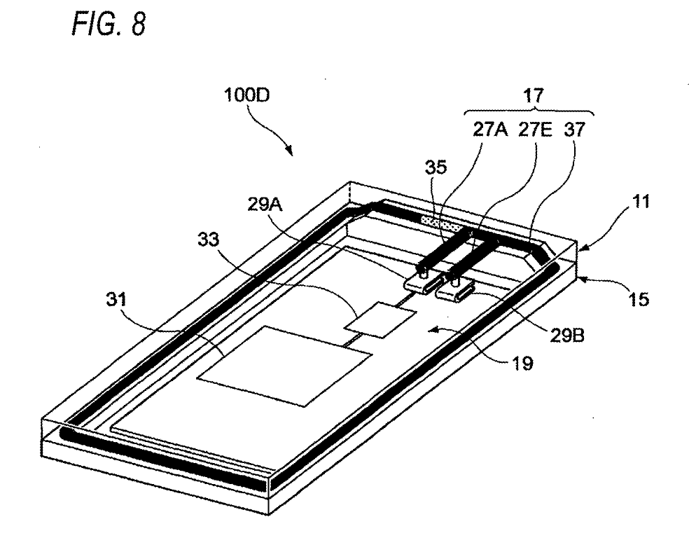

FIG. 8 is a schematic diagram showing a fourth modification of the portable radio of the first embodiment of the present invention.

As shown in FIG. 8, a portable radio 100D includes two types of electric connection terminals; namely, the feed terminal 29A and the earth terminal 29B, provided on the circuit board 19. The feed extension part 27A extends from one end of the second extension part 37 that is to be joined to the first extension part 35, and the feed extension part 27A is connected to the feed terminal 29A. An earth extension part 27E extends from a neighborhood of the second extension part 37 joined to the feed extension part 27A. The earth extension part 27E is connected to the earth terminal 29B.

An area from the point of the conductive second extension part 37 connected to the feed extension part 27A to the other end (end) of the second extension part 37 is embodied as the nonconductive first extension part 35.

The configuration provides the same high waterproof property and dust resistance property as those yielded in the above, and the second extension part 37 serves as the antenna element 17 of inverted F type. Thus, a distance between the ground of the circuit board and the antenna element can be reduced, whereby the size of the portable radio itself can be further miniaturized.

As mentioned above, in the configurations of the portable radios 100, 100A, 100B, 100C and 100D of the present embodiment, various types of antennas, such as a monopole antenna, a dipole antenna, a loop antenna, and an inverted F-type antenna, can be formed from the seal member 13, which provides an enhanced degree of design freedom.

### Second Embodiment

A portable radio of a second embodiment of the present invention is now described.

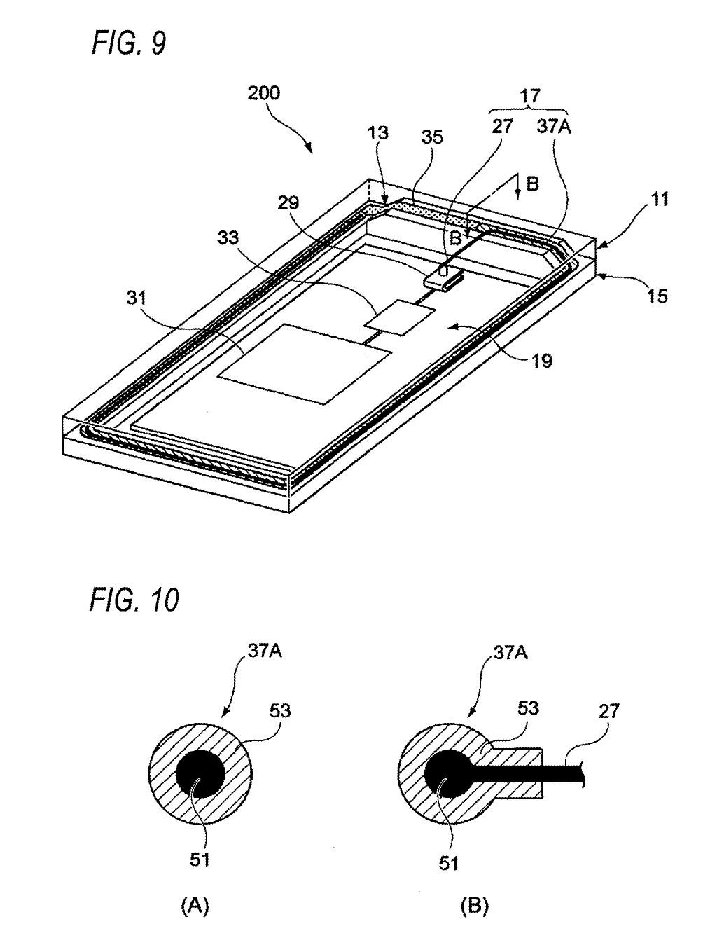

FIG. 9 is a schematic diagram showing an example configuration of the portable radio of the second embodiment of the present invention.

FIG. 10(A) shows a cross sectional view of a second extension part, and FIG. 10(B) shows a cross sectional view of the second extension part taken along line B-B shown in FIG. 9.

As shown in FIG. 9, a portable radio 200 of the present embodiment is similar to the portable radio of the first embodiment except that the second extension part 37 shown in FIG. 1 is replaced with a second extension part 37A whose surface is nonconductive. As shown in FIG. 10(A), the second extension part 37A is made up of a conductive core material 51 and a jacketing material 53 that covers an exterior of the core material 51 and that is made of a nonconductive material. The configuration may also be embodied as a configuration of the aforementioned loop or inverted-F-type antenna.

As shown in FIG. 10(B), a connection between the second extension part 37A and the connection extension part 27 is implemented by means of the connection extension part 27 penetrating through the jacketing material 53 and being electrically connected to the core material 51.

As mentioned in connection with the first embodiment, a conductive elastic material, which is produced by mixing an elastic material, like silicon rubber, with a conductive filler, like carbon black, and vulcanizing (cross-linking) the mixture, can be used for the core material 51. Even in this case, the materials are selected and prepared in such a way that the first extension part 35 and the second extension part 37A exhibit substantially the same hardness in the seal member 13.

In the configuration, an exterior of the conductive core material 51 is covered with the non-conductive jacketing material 53, whereby an outer surface of the second extension part 37A becomes nonconductive. Therefore, even when the seal member 13 is immersed in water, like the portable radio 200 being submerged, insulation is reliably maintained outside the core material 51, which can lessen the deterioration of the antenna characteristic.

The core material 51 can also be made of a wire, such as copper and aluminum. The essential requirement for such a case is to select a material of the jacketing material 53 and a material of the first extension part 35. The essential requirement in that case is to select the jacket material 54 and the material of the first extension part 35 in such a way that hardness of the second extension part 37A and hardness of the first extension part 35 become substantially equal to each other.

### Third Embodiment

A portable radio of a third embodiment of the present invention is now described.

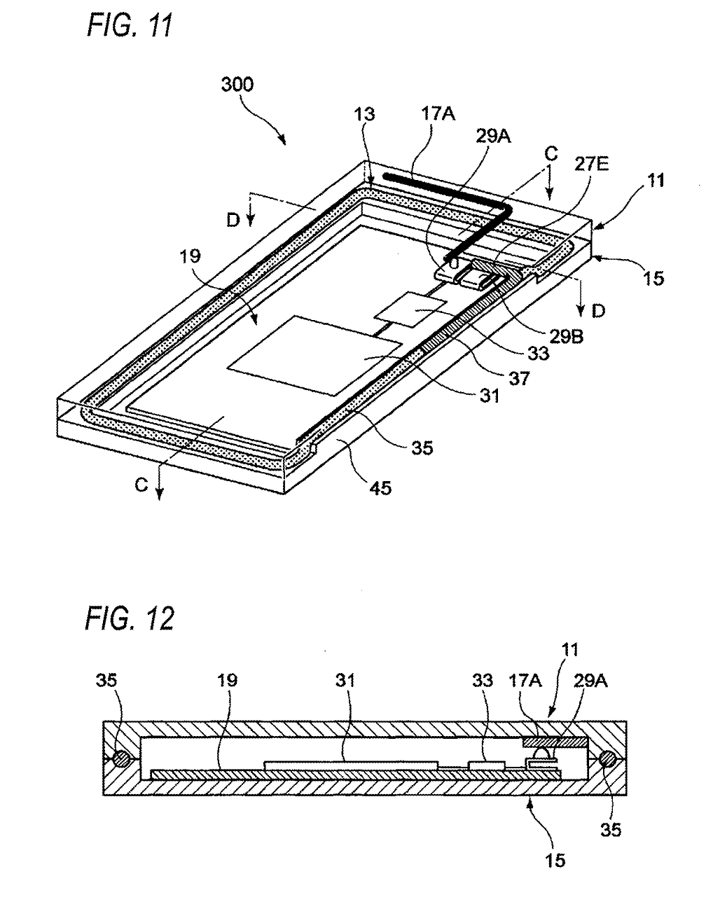

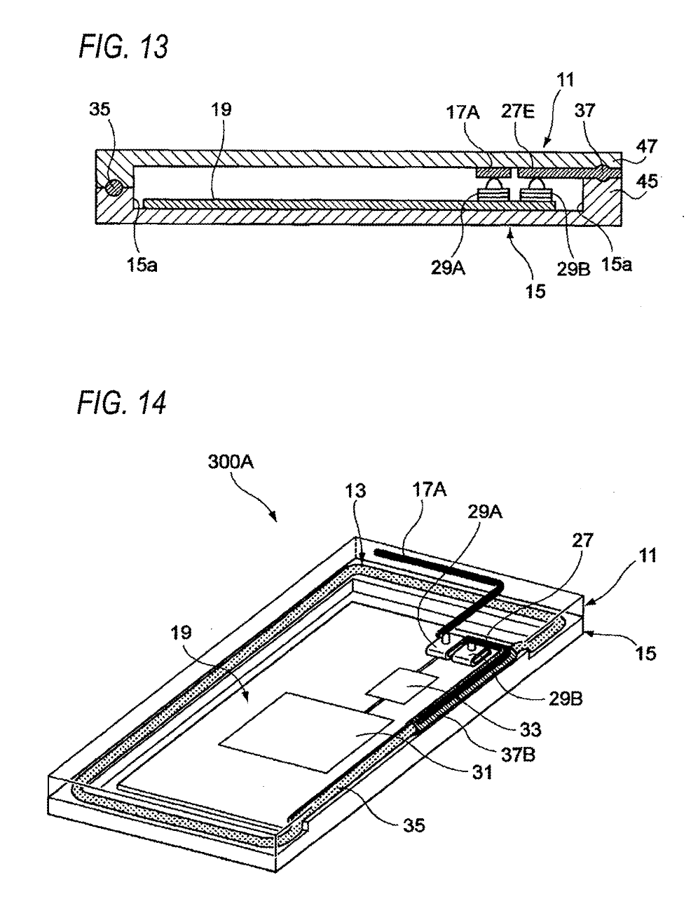

FIG. 11 is a schematic diagram showing an example configuration of the portable radio of the third embodiment of the present invention, and FIG. 12 is a cross sectional view taken along line C-C shown in FIG. 11. FIG. 13 is a cross sectional view taken along line D-D shown in FIG. 11.

As shown in FIG. 11, in a portable radio 300 of the present embodiment, the circuit board 19 is provided with two types of electric connection terminals, such as the feed terminal 29A and the earth terminal 29B. The feed terminal 29A is connected to an antenna element 17A, and the earth terminal 29B is connected to the earth extension part 27E extending from the second extension part 37.

The antenna element 17A of this case is a rod-like or plate-like conductor that is separate from the seal member 13. In addition to being placed alone as shown in an example illustration, the antenna element 17A can also be shared by a conductor member (e.g., a metal hinge, a frame member, or the like) making up the portable radio 300. In the example configuration shown in FIG. 12, the antenna element 17A is placed along an inner surface of the upper case 11 and bonded and fixed to the upper case 11 as required.

As shown in FIG. 13, a protrusion 45 protruding toward the upper case 11 is formed in a portion of the sidewall 15a of the lower case 15. An indentation 47 corresponding to the protrusion 21 is formed at a position on the upper case 11 facing the protrusion 45, whereby the earth extension part 27E extends along an inner surface of the upper case 11.

When the upper case 11 and the lower case 15 are joined, the antenna element 17A is electrically connected to the feed terminal 29A of the circuit board 19, whereupon the earth extension part 27E comes to be electrically connected to the earth terminal 29B.

The second extension part 37 made up of a portion of the seal member 13 is placed along the top surface of the protrusion 45 and set to a predetermined length in conformance to the earth extension part 27E. The second extension part 27D and the earth extension part act as an earth line. Further, the other seal member 13 is embodied as the nonconductive first extension part 35.

As mentioned above, according to the configuration of the portable radio 300 of the embodiment, high waterproof property and dust resistance property similar to those exhibited in the previous embodiment are also yielded, and the earth line can be formed from the seal member 13. Hence, a necessity for providing an earth line as another component is obviated, which contributes to miniaturization of the portable radio 300. Further, the earth extension part 27D and the second extension part 37 act as the earth line, whereby a superior antenna characteristic is yielded.

The second extension part 37 shown in FIG. 11 can also be implemented by means of a two-layer structure made up of a core material and a jacketing material, such as that shown in FIG. 10(A). FIG. 14 is a schematic diagram showing a portable radio 300A employing a second extension part 37B whose exterior is covered with a nonconductive jacketing material. In this case, even when the seal member 13 is immersed in water, like the portable radio 300A being submerged, insulation is reliably maintained outside the core material, and a reduction in operating effect of the earth line can be prevented. Hence, deterioration of the antenna characteristic can be lessened.

The antenna element 17A is not limited to the above-mentioned configuration; may also be placed at any location; and can also be changed in design as required.

### Fourth Embodiment

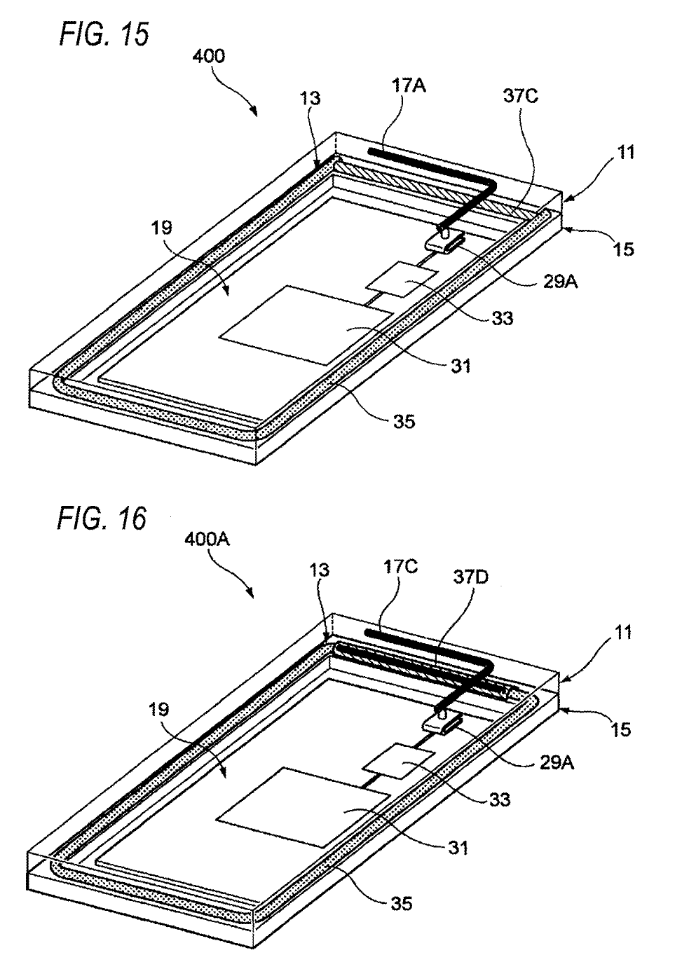

A portable radio of a fourth embodiment of the present invention is now described. FIG. 15 is a schematic diagram showing an example configuration of the portable radio of the fourth embodiment of the present invention.

In a portable radio 400 of the present embodiment, the antenna element 17A is connected to the feed terminal 29A of the circuit board 19, and a second extension part 37C made up of a portion of the seal member 13 is placed at a position corresponding to the antenna element 17A. Further, the other seal member 13 is made as the nonconductive first extension part 35.

In the illustrated embodiment, the antenna element 17A is placed on the inner surface of the upper case 11. When the upper case 11 and the lower case 15 are joined, the antenna element 17A is electrically connected to the feed terminal 29A of the circuit board 19.

The second extension part 37C becomes a passive element and serves as a reflector of the antenna element 17A.

As mentioned above, according to the configuration of the portable radio 400 of the embodiment, high waterproof property and dust resistance property similar to those exhibited in the previous embodiment are also yielded, and the passive element can be formed from the seal member 13. Hence, a necessity for providing a passive element as another component is obviated, which contributes to miniaturization of the portable radio 400. Further, since a distance of the ground of the circuit board 19 can be assured, an operating effect of the passive element becomes greater, so that a superior antenna characteristic is yielded.

Even in this case, the second extension part 37C shown in FIG. 15 can also be implemented by means of a two-layer structure made up of a core material and a jacketing material, such as that shown in FIG. 10(A). FIG. 16 is a schematic diagram showing a portable radio 400A employing a second extension part 37D whose exterior is covered with a nonconductive jacketing material. Even in this case, even when the seal member 13 is immersed in water, like the portable radio 400A being submerged, insulation is reliably maintained outside the core material, and a reduction in operating effect of the passive element can be reduced. Hence, deterioration of the antenna characteristic can be lessened. Thus, an amount of improvement in antenna characteristic can be increased.

In the portable radios described in connection with the respective embodiments, the shape of the enclosure is not limited to that described in connection with the illustrated embodiments. For instance, the upper case 11 has the sidewall 11a, and the lower case 15 has the sidewall 15a. However, one of the cases can also be a cover like a flat plate. Further, the enclosure can also be an enclosure split into three or more parts. Moreover, the configuration of the seal member 13 can also be applied to a battery cover that closes an area where a battery is to be housed.

As mentioned above, the present invention is not limited to the portable radios described in connection with the embodiments and also expected to be susceptible to alterations and applications conceived by the persons skilled in the art on the basis of the descriptions of the present patent specification and the well-known techniques. The alterations and modifications shall fall within the range where protection of the present invention is sought. Moreover, the constituent elements described in connection with the embodiments can also be arbitrarily combined without departing the range of gist of the present invention.

The present patent application is based on Japanese Patent Application (JP-2009-129090) filed on May 28, 2009, the entire subject matter of which is incorporated herein by reference.

### INDUSTRIAL APPLICABILITY

The present invention is useful as a portable radio, or the like, that exhibits high waterproof property and dust resistance property without impairing toughness and antenna performance while pursuing a smaller size.

### DESCRIPTIONS OF THE REFERENCE NUMERALS AND SYMBOLS

11 FIRST CASE MEMBER (UPPER CASE)
13 SEAL MEMBER
15 SECOND CASE MEMBER (LOWER CASE)
17, 17A ANTENNA ELEMENT
19 CIRCUIT BOARD
21 PROTRUSION
23 INDENTATION
25 TRENCH
27 CONNECTION EXTENSION PART
27A, 27C, 27D FEED EXTENSION PART
27B, 27E EARTH EXTENSION PART
29 CONNECTION TERMINAL
29A, 29C, 29D FEED TERMINAL
29B EARTH TERMINAL
35 FIRST EXTENSION PART
37, 37A, 37B, 37C, 37D, 37E, 37F SECOND EXTENSION PART
36 THIRD EXTENSION PART
39 DISSIMILAR MATERIAL INTERFACE
49 BALUN
51 CORE MATERIAL
53 JACKETING MATERIAL
100, 100A, 100B, 100C, 100D, 200, 300, 300A, 400, 400A PORTABLE RADIO

1. A portable radio, comprising a first case member and a second case member to be joined to a surrounding area of an opening of the first case member by a soft seal member, and in which a circuit board connected to an antenna element is housed inside a case resulting from the first case member joined to the second case member,
wherein the seal member has an annular structure including a first extension part made of a non-conductive material, and a second extension part to be connected to both ends of the first extension part, in which a conductive material included in at least a portion of the second extension part serves as the antenna element, a passive element, or an earth line; and wherein the seal member has substantially the same hardness in the first extension part and the second extension part.

2. The portable radio according to claim 1, wherein the second extension part is made of a conductive elastic member prepared by dispersing a conductive filler in an elastic material.

3. The portable radio according to claim 1, wherein the second extension part is made up of a conductive core material and a jacketing material that covers an exterior of the core material and that is made of a nonconductive material.

4. The portable radio according to claim 1, wherein the seal member is put on the surrounding area of the opening of either the first case member or the second case member, and the circuit board equipped with an electrical connection terminal is put in either one of the case members, wherein the second extension part is connected to a connection extension part that extends from a portion of the second extension part along an inner surface of the one case member, and wherein the connection extension part and the electric connection terminal are electrically connected when the case members are joined.

5. The portable radio according to claim 4, wherein the connection extension part extends from a portion of the second extension part toward an interior of the seal member having an annular structure.

6. The portable radio according to claim 4, wherein the second extension part is fed with electrical power from the electric connection terminal of the circuit board, thereby making up a monopole antenna element.

7. The portable radio according to claim 4, wherein the second extension part is split into two; a third extension part connects the two second extension parts together and is made of a nonconductive material; and the two second extension parts are fed with electric power from the electric connection terminal of the circuit board, thereby making up a dipole antenna element.

8. The portable radio according to claim 4, wherein both ends of the second extension part are fed with electric power from the electric connection terminal of the circuit board, thereby making up a balanced loop antenna element.

9. The portable radio according to claim 4, wherein the electric connection terminal of the circuit board is made up of a feed terminal and an earth terminal; the connection extension part has a feed extension part that extends out of one end of the second extension part and that is connected to the feed terminal and an earth extension part that extends out of another end of the second extension part and that is connected to the earth terminal; and the second extension part makes up an unbalanced loop antenna element.

10. The portable radio according to claim 4, wherein the electric connection terminal of the circuit board is made up of a feed terminal and an earth terminal; the connection extension part has a feed extension part that extends out of one end of the second extension part and that is connected to the feed terminal and an earth extension part that extends out of a point on the second extension part close to a location connected to the feed extension part; and the second extension part makes up an inverted-F antenna element.

11. The portable radio according to claim 4, wherein the electric connection terminal of the circuit board is made up of a feed terminal and an earth terminal; the antenna terminal is connected to the feed terminal; an extension part terminal extending out of the second extension part is connected to the earth terminal; and the second extension part makes up an earth line.

12. The portable radio according to claim 1, wherein the seal member is put on the surrounding area of the opening of any one of the first and second case members; the circuit board and the antenna element are arranged in any case member; the antenna element and an electric connection terminal provided on the circuit board are electrically connected together; and
the second extension part makes up a passive element.

13. The portable radio according to claim 4, wherein the electric connection terminal of the circuit board is made up of an elastic metal forcing member that presses the connection extension part when the case members are joined together.

14. The portable radio according to claim 12, wherein the electric connection terminal of the circuit board is made up of an elastic metal forcing member that presses the connection extension part when the case members are joined together.
